(19) United States
(12) Patent Application Publication
(10) Pub. No.: US 2026/0057362 A1
(43) Pub. Date: Feb. 26, 2026

(54) PAYMENT INDICATOR ON MOBILE DEVICE

(71) Applicant: Wells Fargo Bank, N.A, San Francisco, CA (US)

(72) Inventors: Praveen Kumar Bharti, Bangalore (IN); Mutturaj Mundewadi, Bangalore (IN); Govinda Rajulu Nelluri, Hyderabad (IN); Lalitha Ramakrishnan, Hyderabad (IN)

(21) Appl. No.: 18/811,258

(22) Filed: Aug. 21, 2024

(51) Int. Cl. G06Q 20/20

(52) U.S. Cl. CPC G06Q 20/204; G06Q 20/202

(57) ABSTRACT

A computer system for indicating payment options can include: one or more processors; and non-transitory computer-readable storage media encoding instructions which, when executed by the one or more processors, causes the computer system to: receive a request from a client device for accepted payment options for business in the vicinity of the computer system; identify at least one point of sale device; identify accepted payment options from the at least one point of sale device; send a signal to the client device indicating the accepted payment option associated with the at least one point of sale device.

### BACKGROUND

Businesses often have different requirements for payment or accept different forms of payment. Customers may desire to use a certain form of payment or may not have the required form of payment when shopping. Customers may attempt to pay and realize that their form of payment is not accepted at specific businesses. When their form of payment is rejected, the customers may not be able to make desired purchases or otherwise have negative experiences.

### SUMMARY

Examples provided herein are directed to payment option indicators.

According to one aspect, a computer system for indicating payment options can include: one or more processors; and non-transitory computer-readable storage media encoding instructions which, when executed by the one or more processors, causes the computer system to: receive a request from a client device for accepted payment options for a business in the vicinity of the computer system; identify at least one point of sale device of the business; identify accepted payment options from the at least one point of sale device; send a signal to the client device indicating the accepted payment option associated with the at least one point of sale device.

According to another aspect, an example method for indicating payment options from a computer system, the method comprising: receiving a request from a client device for accepted payment options for a business in the vicinity of the computer system; identifying at least one point of sale device of the business; identifying accepted payment options from the at least one point of sale device; sending a signal to the client device indicating the accepted payment option associated with the at least one point of sale device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing payment option indicators.

FIG. 2 shows example logical components of a server device of the system of FIG. 1.

FIG. 3 shows example additional logical components of a server device of the system of FIG. 1.

FIG. 4 shows example logical components of a client device of the system of FIG. 1.

FIG. 5 shows example display screen including a payment indicator icon of the client device of the system of FIG. 1.

FIG. 6 shows another example display screen including payment option indicators of the client device of FIG. 5.

FIG. 7 shows example payment indicator icon of the third party device of the system of FIG. 1.

FIG. 8 shows example physical components of the server device 112 of FIG. 2.

### DETAILED DESCRIPTION

This disclosure relates to indicating payment options for businesses within a vicinity of client devices.

In some examples, a client device or devices may interact with a server device to determine a business, forms of payment associated with the client device, and accepted forms of payment by the business. Advantageously, the client device may alert a customer to forms of payment before having to pay and/or reaching the store. As such, customer discomfort may be reduced by avoiding situations where a preferred method of payment is not accepted when attempting to pay. Further, customer convenience may be improved by notifying a customer of faster forms of payment without waiting in line or interacting with personnel at the store.

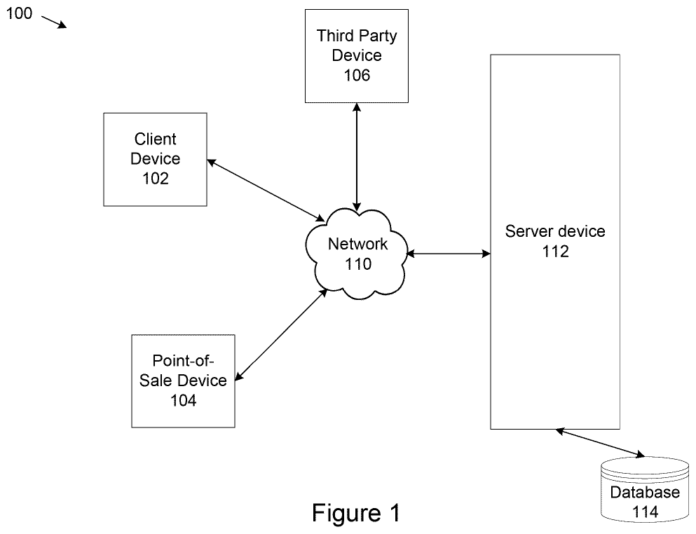

FIG. 1 schematically shows aspects of one example system 100 programmed to indicate payment options to customers. The system 100 can be a computing environment that includes a plurality of client and server devices.

In this instance, the system 100 includes a client device 102, a point of sale operating device (POS) 104, a third party device 106, a server device 112, and a database 114. The client device 102, the point-of sale operating device 104, and the third party device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102, the POS device 104, and the third party device 106 can be programmed to communicate with the server device 112 to indicate an accepted payment option or multiple accepted payment options for financial transactions. Payment options may refer to any electronic or physical form of payment. Many other configurations are possible.

The example server device 112 is programmed to determine the accepted payment options for one or more businesses within the vicinity of the client device 102. For instance, the server device 112 is programmed to transmit accepted payment options associated with one or more businesses within a vicinity of the customer who is interacting with the client device 102. In some examples, the server device 112 may be programmed to detect a preferred available payment option from a client device 102. The vicinity of customer may vary depending on the range of connectivity of the client device 102 to the network 110. The server device 112 may communicate the accepted payment option to the client device 102 which matches the preferred available payment option as a preferred accepted payment option. Further, the server device 112 is programmed to initiate transactions between the client device 102 or POS device 104.

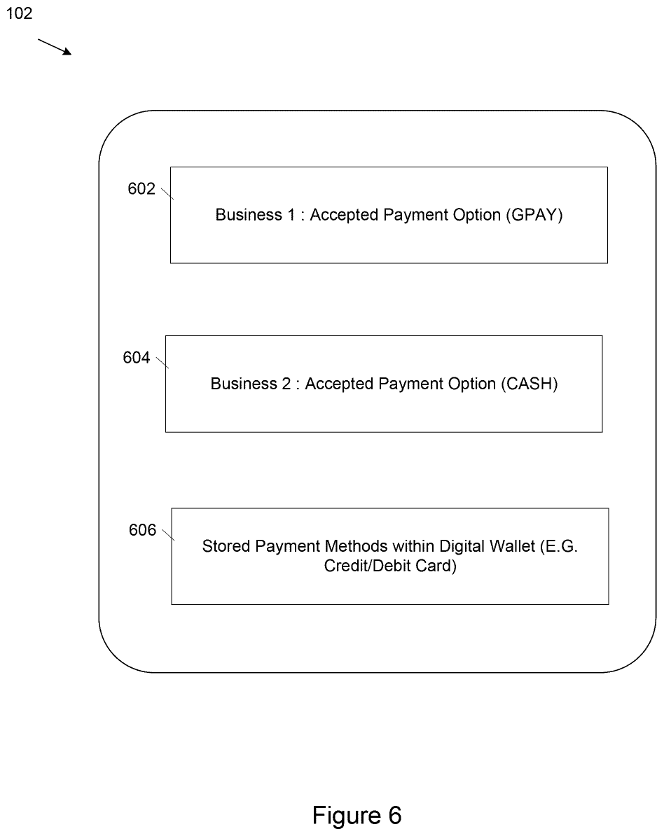

The example client device 102 is programmed to receive and display the accepted payment options from the server device 112. An embedded finance protocol may be used to control a payment option icon (see FIG. 6) for the client device 102 and communications with the server device 112 to initiate the processing of financial transactions using the payment option icon. For instance, the client device 102 can be programmed to receive a selection (e.g., touch or click) from the customer to initiate a request for the accepted payment options of a business in the vicinity.

In some examples, the client device 102 may also provide context data to the server device 112 which is utilized in determining accepted payment options to be provided to the client device 102. Context data refers to information or data that provides background or additional details about a particular situation, event, or subject. The context data helps to provide a better understanding of the circumstances surrounding the data or the context in which it was collected or analyzed. As a non-limiting example, the context data may indicate information relating to the type of transaction. While only a single client device 102 is show, it should be understood that multiple client devices may be connected within the system 100. It is further possible the system 100 may use context data of multiple client devices in the determination of accepted payment options.

The example POS device 104 is programmed to receive and send requests for payments for a business. The POS device 104 may be programmed to provide financial transaction data to the server device 112. For instance, the POS device 104 may send information of previous financial transactions or accepted payment options to the server device 112. The POS device 104 may be hardware, such as tablets, programmed devices, computers, and/or cash registers. In other instances, POS device 104 may be software (i.e., online store) which interacts with the server device 112. Further, the POS device 104 may indicate the presence of the business in the vicinity to the server device 112.

The example third party device 106 is programmed to provide data from outside of the system 100 to either the client device 102, the POS device 104, and/or the server device 112. In some examples, this data can be financial information or context data associated with one or more organizations, businesses, and or industries associated therewith. For instance, the information can be trends within financial transactions associated with the businesses or industries, etc.

In some examples, the third party device 106 may have agents associated with operating the third party device 106 to deliver information from outside the system 100 to the server device 112 or client device 102. In some instances, the information could be used to discriminate information about the accepted payment options. In other instances, the information may update POS data related to the POS device interacting with the client device 102.

The example database 114 is programmed to store information related to POS device 104, payment aggregators, partner systems and customer profiles. In one example, the database 114 stores information of a business operating the POS device 104, a customer profile, and payment aggregators which can be used by the POS device 104 and the server device 112. The customer profile may indicate an available payment option and/or customer preference for the server device 112 to analyze in determining the accepted payment option. For instance, the server device 112 may compare with data of the customer profile to determine whether one or more payment options utilized by a customer are accepted by the business to determine the accepted payment option. Further, the database 114 is programmed to store payment information associated therewith to allow the server device 112 to provide payment option indicators to the client device, as described further below in relation to FIG. 6. Payment Option indicators may display the accepted payment option or options on the client device 102.

The network 110 provides a wired and/or wireless connection between the client device 102, POS device 104, third party device 106 and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

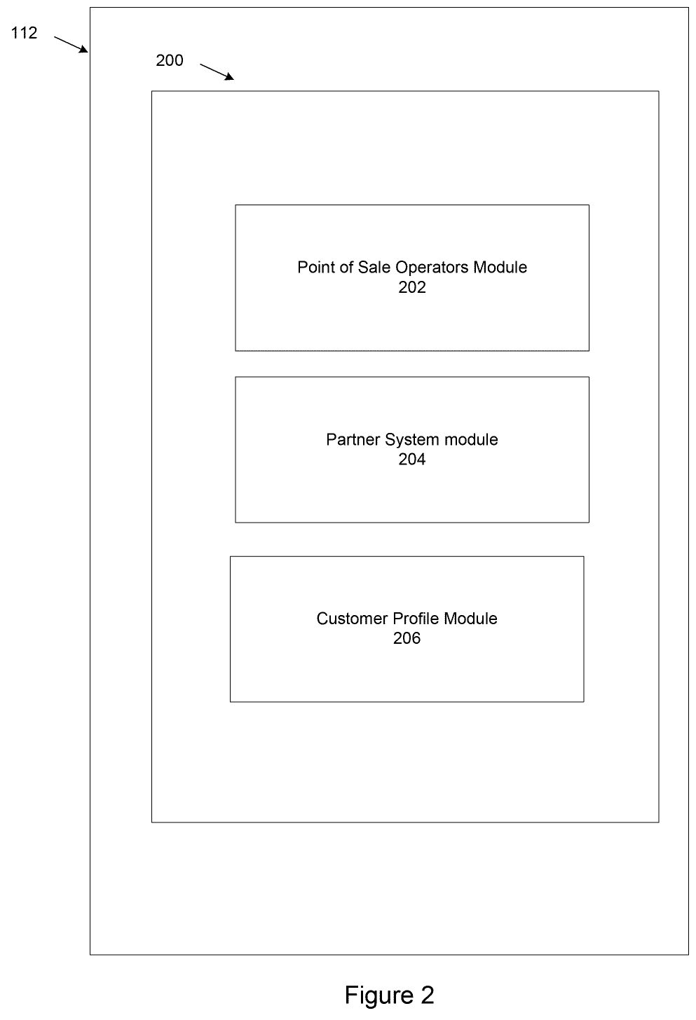

Referring now to FIG. 2, additional details of the server device 112 are shown. In this example, the server device 112 has various logical modules that assist in determining accepted payment options output to the client device 102. The server device 112 can, in this instance, include an integration module 200. The integration module 200 may include a point of sale (POS) operator module 202, a partner system module 204, and a customer profile module 206. In other examples, more or fewer modules providing different functionality can be used.

The POS operator module 202 is programmed to identify the POS device 104 within the vicinity of the client device 102. In general, the POS operator module 202 determines the POS device 104 available to perform financial transactions with client device 102.

The POS operator module 202 may be programmed to identify the POS device 104 through Wi-Fi connectivity, telecom spectrums 5G, Bluetooth or other forms of connectivity. In other examples, the POS device 104 may simply be identified as stored data within the database 114.

In some examples, the third party device 106 may input data into the system 100 to identify the POS device 104 or correct identifying information associated with the POS device 104. In other instances, the third party device 106 may identify the POS device 104 that is connected to the network 110 but are not currently determined as POS device 104.

The partner system module 204 is programmed to identify partner systems which can perform payment processing. Partner system may include payment aggregators (i.e., Alipay, Google Pay, Stripe) or local banks. Payment aggregators may be services stored on the client device 102, such as software, which enable businesses and/or customers to send or receive payments. Payment aggregators are third party services which allow the use of multiple forms of electronic payment. For instance, payment aggregators may enable the use of debit/credit cards, bank transfers, digital walls, etc. As such the partner system module 204 stores known payment aggregators collected from various sources such as previous financial transactions when identifying accepted payment options.

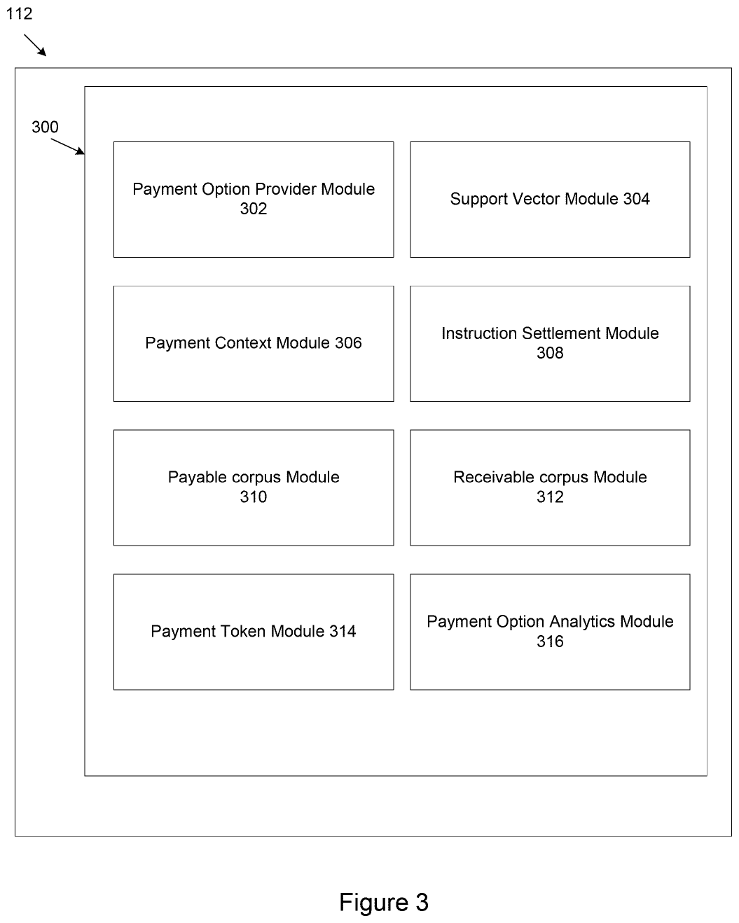

Different businesses may use different payment aggregators based on service charges and other fees. The partner system module 204 may store data indicating whether the business allows the use of one or more payment aggregators. The partner system module 204 may deliver the one of the partner systems as accepted payment options to a payment option module 300, which will be described in greater detail later. See FIG. 3. In general, the partner system module 204 looks at various factors, such as stored payment aggregator data for respective business, payment and receivables information and location. In some instances, the partner system module 204 may also store information of local banks which may alternatively process financial transactions.

The customer profile module 206 is programmed to create customer profiles. The customer profile module 206 may also store payment option information and preferences of a customer associated with each client device 102. The customer profile module 206 may detect client device 102 communicating with the server device 112. Based on the client device 102, the customer profile stored within the server device 112 assists in optimizing the accepted payment option provided to the client device 102.

In some examples, the customer profile module 206 may store available payment options and identify a preferred available payment option from the most utilized payment method of previous financial transitions. In some instances, the preferred available payment option may be determined on a hierarchy of the available payment options. In other instances, the preferred available payment option may be determined from the type of financial transaction or benefits the customer may receive using a particular payment option (e.g., rewards for using a particular credit card). In general, the customer profile module 206 looks at various factors, such as previous payments of the client device 102 and receivables information, types of purchases, and location. The customer profile module 206 may also receive and store information from the payment option provider indicating a determined accepted payment option.

Referring now to FIG. 3, the payment option module 300 of the server device 112 has various logical modules that determine accepted payment options. Typically, the accepted payment options are determined based on a request from the client device 102. The payment option module 300 can, in this instance, include a payment option provider module 302, a payment context module 304, a support vector module 306, an instruction settlement module 308, a payable corpus module 310, a receivable corpus module 312, a payment token module 314, and a payment option analytics module 316. In other examples, more or fewer modules providing different functionality can be used.

The payment option provider module 302 is programmed to identify the POS device 104 which is ready to perform financial transactions. Typically, the POS device 104 will need connectivity to the network to request payments be made through payment aggregators; however, in some instances cash or credit card may be the only payment option utilized if payment aggregators or local banks are not allowed. In these instances, the payment option provider module 302 may still indicate a POS device 104 is operable but that cash or credit card is the accepted payment option. In some examples, the payment option provider module 302 may receive information about the POS device 104 from the POS operator module 202.

Further, the payment option provider module 302 is programmed to receive signals from the POS operator module 202 to determine the accepted payment options. As a non-limiting example, the payment option provider module 302 may receive a signal from the POS device 104 indicating Google Pay or a credit card as accepted payment options. The payment option provider module 302 may also receive data from multiple other modules in both the integration module 200 and payment option module 300 to determine all accepted payment options and/or the preferred accepted payment option of the client device 102.

The payment context module 304 is programmed to gather an initial context data set from the client device 102 and POS device 104. Context data may be used to determine preferences of businesses, preferences of the client device 102, and whether POS device 104 have become inoperable. In some examples, the initial context data set may also be used to determine differences between a local store of a larger business entity such as a chain store. The payment context module 304 may collect the initial context data set based on GPS locations, a time of day, the POS device 104 being communicated with by the server device 112, and previous financial transactions. Non-limiting examples of the initial context data set from the client device 102 may include most frequently used payment methods, other POS device business interacted with by the client device 102, and discounts or earnings associated with payment methods (i.e., credit card earning percentages).

Further, the payment context module 304 may analyze the context data to determine a relevant context data set and an excess context data set. For instance, the payment context module 304 may identify relevant context data based on the user's current location, and/or a financial transaction within a recent period of time from the request for the payment option indicator.

As an example, a financial transaction using a payment aggregator such a Google Pay or Alipay within an hour of the request may provide context for determining the preferred payment option. The excess context data set may include information not related to transaction, such as purchases outside the period of time, or an interaction with a different business or POS device 104. As such, the payment context module 304 limits the consideration of the excess context data set which might reduce the accuracy in the determination of preferred accepted payment options.

Relevant context data could indicate numerous aspects about the POS device 104. For instance, the POS device 104 may be in communication with the network 110 and server device 112; however, if an electronic payment over network 110 has not have been initiated over long periods of time, the relevant context data set may indicate that the POS device 104 does not prefer electronic payments. Once the relevant context data is determined, the payment context module 304 eliminates the excess context data from the initial context data set and saves the relevant context data to be used by the payment option provider module 302.

The payment option provider module 302 may be programmed to communicate with the support vector module (SVM) 306. The SVM module 306 is programmed to assist machine learning by classifying data and detecting outlier data. The SVM module 306 analyzes the context data to optimize the determination of the accepted payment option based on the context data.

Additionally, the SVM module 306 may use machine learning to classify businesses which prefer cash, cards, or applications of payment aggregators. Further, the SVM module 306 may analyze the previous financial transactions to determine all of the accepted payment options and determine the best/preferred accepted payment options based on the client device 102, as indicated by the customer profile module 206, and any benefits associated with each accepted payment option. The preferred accepted payment option may be recommended before other accepted payment options.

The instruction settlement module 308 is programmed to process the financial transaction between the client device 102 and the POS device 104. In one example, the instruction settlement module 308 is divided into a payable corpus module 310 and a receivable corpus module 312. The payables corpus module 210 and the receivable corpus module 312 are programmed to store and order payables and receivables data. Further, the instruction settlement module 308 is programmed to store and send information on the requested settlements to payment aggregators and partner systems.

The instruction settlement module 308 additionally includes a payment token module 314. The payment token module 314 is programmed to use payment token when exchanging financial information during the settling of financial transactions. As such, the server device exchanges tokens instead of the financial information directly. The token may be used to trace or associate the financial transaction back to the POS device 104 and/or client device 102 when later processed. The payment token module 314 adds a security layer to the exchange of financial information while the server device 112 enables the processing of financial transactions.

In the example server device 112, the payment option provider module 302 may receive context data from the payment context module 304 to determine the preferred available payment option of the client device 102 which is also accepted by the POS device 104. The payment option provider module 302 may recommend this as the preferred accepted payment option. This may be determined based on information received from the customer profile module 206. If none of the preferred available payment options is accepted, the payment option provider module 302 determines other accepted payment options to provide the client device 102.

The payment option provider module 302 may send/receive data to the instruction settlement module 308 to provide information to partner systems/payment aggregators processing the transactions. As will be described in greater detail later, the payment option provider module 302 communicates with a payment option icon module 402 (shown in FIG. with the client device 102 to display the accepted payment options to the client device 102. Further, although the server device 112 preferably determines accepted payment options, the payment option provider module 302 may also indicate non-acceptable payment options to the client device 102.

In some instances, a payment option analytics module 316 may be provided to inform the payment option provider module 302 about possible results of a financial transaction. The payment option analytics module 316 is programmed to determine information usage, hidden charges, and security risks to the clients. The payment option analytics module 316 receives the determined preferred accepted payment option and analyzes aspects of the transaction for risks. For instance, some payment aggregators may have previous instances of security risk for being hacked or certain business may have a risk of giving out undesired financial information. The analytics module may identify risky business and alert the user before financial transactions of the risky nature of the transaction with the business. The payment option analytics module 316 may provide this information to the client device to be displayed. The payment option analytics module 316 can be programmed to communicate with the client device 102 to display the warnings about the POS device 104 and/or transaction.

As will be described in greater detail later, the payment option provider module 302 may also receive information from the third party device 106 through the network. For instance, financial transaction data within the payment option provider module 302 may be discriminated against by a GAN network to confirm or correct the determination of the preferred accepted payment option.

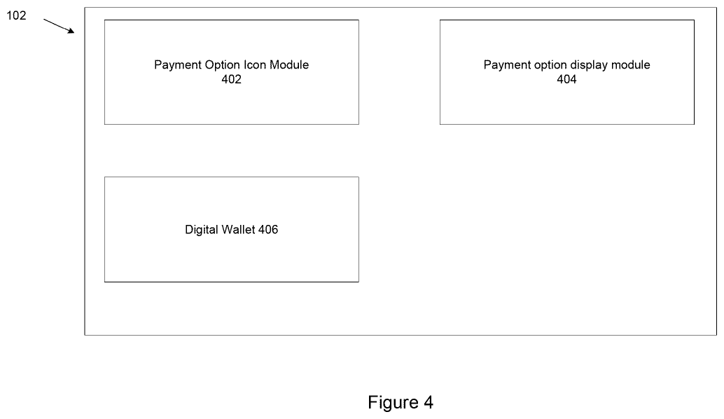

Referring now to FIG. 4, additional details of the client device 102 are shown. The client device 102 may indicate a request to make a payment or identify the types of payment options available at a business. In this example, the client device 102 has various logical modules which initiate a request for available payment options. The client device 102 can, in this instance, include connection a payment option icon module 402, a display module 406, and a digital wallet module 404. In other examples, more or fewer modules providing different functionality can be used.

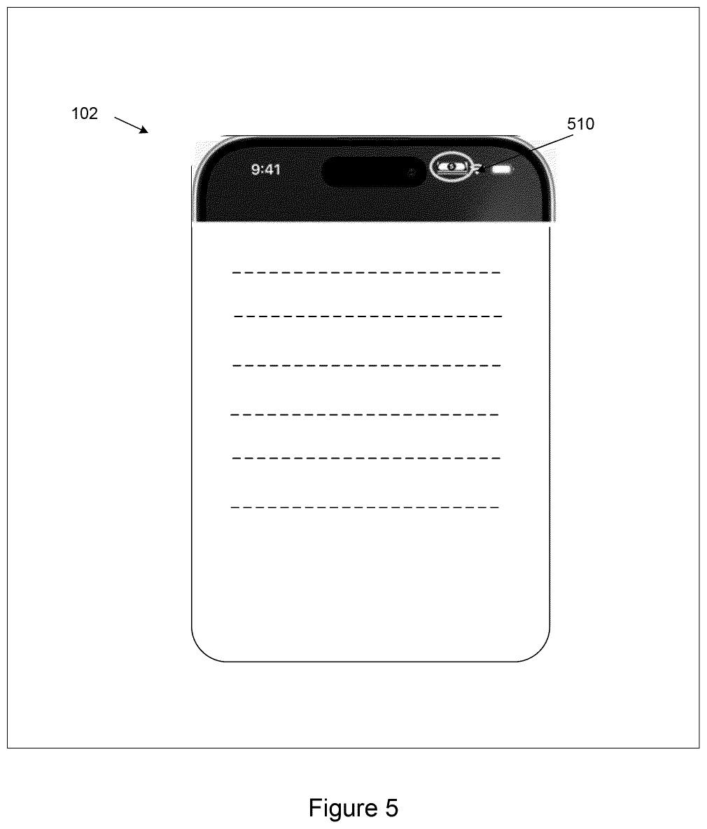

The payment option icon module 402 is programmed to display an icon 510 (shown in FIG. 5) on a display of the client device 102 which requests the accepted payment options. For instance, the payment option icon module 402 can initiate communication with the server device 112. The server device 112 communicates over the network 110 with the client device 102 to transmit the accepted payment option based on determinations from the various modules of the server device 112. As previously described, the accepted payment option may account for a determined preferred payment option from the relevant context data set and the customer profile.

The digital wallet module 404 is programmed to store payment option information on the client device 102. As an example, the digital wallet module 404 may store options such as credit cards, debit cards, banking information, loyalty cards, gift cards, etc. The digital wallet module 404 may store the client device 102 available payment options in a single easily accessible location to be accessed by payment option icon module 402 for display and/or sent to the server device 112 for determining the best form of accepted payment options.

The display module 406 is programmed to display the preferred accepted payment options from the payment option provider module 302 and the other available payment methods within the digital wallet. In some instances, the display module displays the preferred or accepted payment option determined based on the POS device 104 allowing multiple accepted payment options and one of the accepted payment options matching one of the preferred available payment options of the client device 102 which is stored in the customer profile module 206.

Referring to FIG. 5, as previously described, the icon 510 may be selected by a touch or click. In one example, the icon 510 may be displayed on a smart phone as an icon on a touch screen. The icon 510 may be either a feature of an operating system for the client device 102 or an application installed on the client device 102. In some embodiments, the icon 510 is provided as part of the operating system with the client device 102. As such, the client device 102 may update the display of icons and accepted payment options without requiring updating an application but through automatic background updates to the operating system.

The icon 510 initiates the client device 102 to request for accepted payment options from the server device 112 and initiates the display on the client device 102. When selected, the payment option icon module 402 will transmit signals to request an accepted payment option from the server device 112 and signals the display module 406 to display the requested information.

In some instances, the payment option provider module 302 may communicate that POS devices 104 in the vicinity accept electronic forms of payment. Under certain circumstances, the payment option icon module 402 can change the icon 510 displayed based on a communication from the server device 112 indicating that electronic payments are generally accepted in the vicinity. In some examples, the icon 510 displayed may be a symbol generally indicating that payment aggregators are accepted in the vicinity without displaying all the accepted options. In other examples, if no electronic forms of payment options are accepted, the icon 510 may be a different symbol (i.e., a stack of paper money) representing cash as the only accepted payment option in the vicinity. The server device 112 signaling no electronic forms of accepted payment options may also be an instruction to the client device 102 to change the icon 510.

Referring to FIG. 6, the display module 406 may display one or more accepted payment option indicators and stored payment methods of the digital wallet module 404. For instance, the display module 406 may signal the client device 102 to display a first accepted payment option indicator 602 for transaction with a first business (i.e., Google Pay), a second accepted payment option indicator 604 (i.e., CASH) for transactions with second business, and/or a stored payment method indicator 606. It should be understood that more or less accepted payment option indicators could be displayed, and the stored payment method indicator could be omitted if desired. The first accepted payment option indicator 602 and the second accepted payment option indicator 604 may be clicked or touched to request to pay the POS device 104. In some instances, the POS device may include a similar display which allows the POS device 104 to request the client device 102 to pay the business associated with the POS device 104.

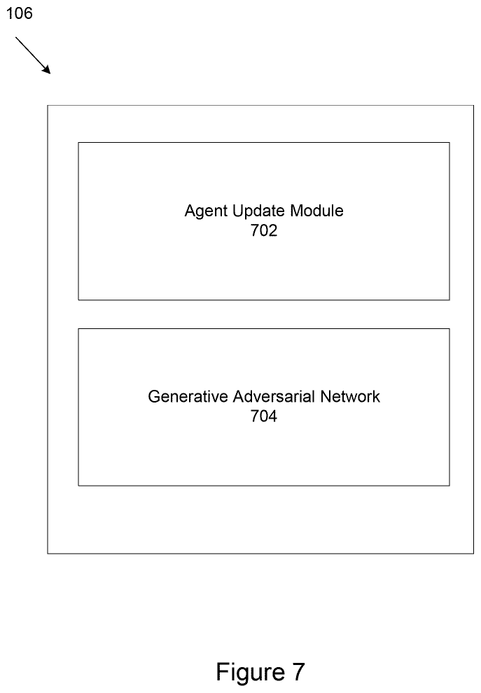

Referring now to FIG. 7, additional details of the third party device 106 are shown. The third party device 106 may provide information from outside third parties to provide known information. For instance, the third party device may provide a service to update information stored on the server device 112. In some examples, server device 112 may request information from the third party device 106 when a client device 102 requests payment options. For instance, the third party device 106 can update the available POS device 104 within the vicinity. The server device 112 communicates over the network 110 with the third party device 106.

The example third party device 106 has various logical modules which provide information from outside third parties to provide known information from relevant financial transactions. In other instances, the third party device 106 may discriminate against the accepted payment options to determine more likely accepted payment options. The third party device 106 can, in this instance, include agent update module 702 and a generative adversarial network (GAN) module 704. In other examples, more or fewer modules providing different functionality can be used.

The agent update module 702 is programmed to allow an agent of the third party device 106 to add information through the network 110 to the server device 112. The agent may be an AI entity which analyzes the information of the POS device 104. The agent may determine information stored on the server device 112 is incorrect. It is understood the agent update module 702 allows the addition of information about the POS device 104; however, the agent update module 702 may additionally update or add information to other modules of the server device 112 as well. For instance, the agent update module may update the partner system module 204 or customer profile module 206.

The GAN module 704 is programmed to discriminate against the determination made by the payment option provider module 302 for correctness. For instance, the GAN module 704 may identify the accepted payment option determined by the payment option provider module 302 and a challenger accepted payment option which is used to discriminate against the determined accepted payment option. The GAN module 704 may apply an algorithm to determine which of the challenger accepted payment option and the accepted payment options determined by the payment option provider module 302 is more reliable. If the determination by the payment option provider module 302 is determined to be incorrect after discrimination, the challenger accepted payment option may instead be relayed to the payment option provider module 302 as the most reliable accepted payment option. The payment option provider module 302 may send the most reliable accepted payment option to the payment option icon module 402 to be displayed. It is understood that multiple accepted payment options may be considered and discriminated at one time. The GAN module 704 is programmed to discriminate conflicting data or information related to the determination of the accepted payment option to provide as at least one of the payment option indicators on client device 102.

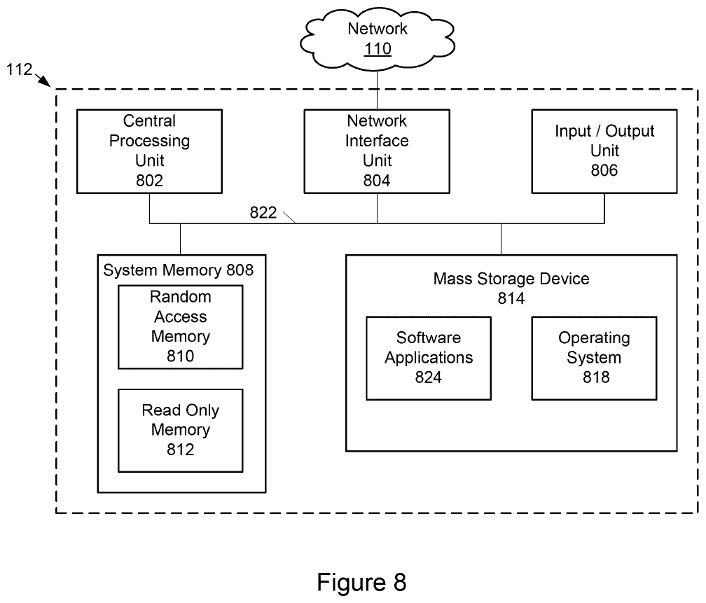

As illustrated in the embodiment of FIG. 8, the example server device 112, which provides some of the functionality described herein, can include at least one central processing unit (“CPU”) 802, a system memory 808, and a system bus 822 that couples the system memory 808 to the CPU 802. The system memory 808 includes a random-access memory (“RAM”) 810 and a read-only memory (“ROM”) 812. A basic input/output system containing the basic routines that help transfer information between elements within the server device 112, such as during startup, is stored in the ROM 812. The server device 112 further includes a mass storage device 814. The mass storage device 814 can store software instructions and data. A central processing unit, system memory, and mass storage device similar to that shown can also be included in the other computing devices disclosed herein.

The mass storage device 814 is connected to the CPU 802 through a mass storage controller (not shown) connected to the system bus 822. The mass storage device 814 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 804 connected to the system bus 822. It should be appreciated that the network interface unit 804 may also be utilized to connect to other types of networks and remote computing systems. The server device 112 also includes an input/output controller 806 for receiving and processing input from a number of other devices, including a touch user interface display screen or another type of input device. Similarly, the input/output controller 806 may provide output to a touch user interface display screen or other output devices.

As mentioned briefly above, the mass storage device 814 and the RAM 810 of the server device 112 can store software instructions and data. The software instructions include an operating system 818 suitable for controlling the operation of the server device 112. The mass storage device 814 and/or the RAM 810 also store software instructions and applications 824, that when executed by the CPU 802, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for indicating payment options comprising:
one or more processors; and
non-transitory computer-readable storage media encoding instructions which, when executed by the one or more processors, causes the computer system to:
receive a request from a client device for accepted payment options for a business in a vicinity of the computer system;
identify at least one point of sale device of the business;
identify the accepted payment options from the at least one point of sale device;
and
send a signal to the client device indicating the accepted payment options associated with the at least one point of sale device.

2. The computer system of claim 1, comprising further instructions which, when executed by the one or more processors, causes the computer system to:
determine a preferred accepted payment option based upon a customer profile associated with the client device; and
indicate the preferred accepted payment option as a recommended one of the accepted payment options if the preferred accepted payment option is included within the accepted payment options.

3. The computer system of claim 2, comprising further instructions which, when executed by the one or more processors, causes the computer system to communicate with the client device to display the preferred accepted payment option.

4. The computer system of claim 1, comprising further instructions which, when executed by the one or more processors, causes the computer system to indicate all accepted payment options for the at least one point of sale device to the client device.

5. The computer system of claim 1, comprising further instructions which, when executed by the one or more processors, causes the computer system to receive context data to determine the accepted payment options.

6. The computer system of claim 5, comprising further instructions which, when executed by the one or more processors, causes the computer system to use machine learning to analyze the context data.

7. The computer system of claim 1, comprising further instructions which, when executed by the one or more processors, causes the computer system to settle a financial transaction between the client device and the at least one point of sale device.

8. The computer system of claim 7, comprising further instructions which, when executed by the one or more processors, causes the computer system to analyze the financial transaction for risks.

9. The computer system of claim 1, wherein the client device is configured to display a payment indicator icon as a feature of the operating system and wherein the payment indicator icon is configured to request and display the accepted payment options.

10. The computer system of claim 9, comprising further instructions which, when executed by the one or more processors, causes the computer system to indicate the accepted payment options as cash if no electronic accepted payment options are accepted by the point of sale device and signal the client device to change the icon displayed on the client device.

11. A method for indicating payment options from a computer system, the method comprising:
receiving a request from a client device for accepted payment options for a business in a vicinity of the computer system;
identifying at least one point of sale device of the business;
identifying accepted payment options from the at least one point of sale device; and
sending a signal to the client device indicating the accepted payment options associated with the at least one point of sale device.

12. The method of claim 11, further comprising:
determining a preferred accepted payment option based upon a customer profile associated with the client device; and
indicating the preferred accepted payment option as a recommended one of the accepted payment options if the preferred accepted payment option is included within the accepted payment options.

13. The method of claim 12, further comprising communicating with the client device to display the preferred accepted payment option.

14. The method of claim 11, further comprising indicating all accepted payment options for the at least one point of sale device to the client device.

15. The method of claim 11, further comprising receiving context data to determine the accepted payment options.

16. The method of claim 15, further comprising utilizing machine learning to analyze the context data.

17. The method of claim 11, further comprising settling a financial transaction between the client device and the at least one point of sale device.

18. The method of claim 17, further comprising analyzing the financial transaction for risks.

19. The method of claim 11, further comprising the client device displaying a payment indicator icon as a feature of the operating system and an interaction with the payment indicator icon requesting and displaying the accepted payment options.

20. The method of claim 19, further comprising indicating the accepted payment options as only cash if no electronic accepted payment options are accepted by the point of sale device and signal the client device to change the icon displayed on the client device.
